(19) United States
(12) Patent Application Publication
(10) Pub. No.: US 2015/0185648 A1
(43) Pub. Date: Jul. 2, 2015

(54) TONER

(71) Applicant: CANON KABUSHIKI KAISHA, Tokyo (JP)

(72) Inventors: Kozue Uratani, Mishima-shi (JP); Michihisa Magome, Mishima-shi (JP); Takashi Matsui, Mishima-shi (JP); Atsuhiko Ohmori, Suntou-gun (JP)

(21) Appl. No.: 14/575,848

(22) Filed: Dec. 18, 2014

(30) Foreign Application Priority Data
Dec. 26, 2013 (JP) 2013-270110

(51) Int. Cl. G03G 9/08

(52) U.S. Cl. CPC G03G 9/0825

(57) ABSTRACT

It is intended to provide toner that has favorable fixability, releasability and few negative effects on images. The present invention provides toner including toner particles each containing a binder resin, a colorant and an ester wax, and silica fine particles, wherein: the ester wax contains a plurality of esters represented by R1-COO—(CH₂)ₓ₁—OOC—R2, or R3-OOC—(CH₂)ₓ₂—COO—R4; (i) when an ester whose content is maximum is designated as “ester A”, a content of the ester A in the ester wax is 40-80%, and (ii) when the ester A has a molecular weight M1, a content of an ester having a molecular weight of M1×0.8-M1×1.2 in the ester wax is 90% or larger; a coverage ratio X1 of the surface of the toner particles with the silica fine particles is 40.0-75.0%; and when a theoretical coverage ratio is defined as X2, a diffusion index (X1/X2) satisfies the following: X1/X2≧−0.0042×X1+0.62.

### BACKGROUND OF THE INVENTION

1. Field of the Invention

The present invention relates to toner for use in recording methods using electrophotography, etc.

2. Description of the Related Art

Image forming apparatuses such as printers or copying machines employ electrophotography.

During the transition from analog to digital technology, these printers or copying machines have been required to have excellent latent image reproducibility and high resolutions as well as stable image quality even in long-term use. In addition, highly fixable toner has been demanded as energy-saving measures. For example, binder resins or waxes have been modified in order to improve fixability.

Here, speaking of waxes, use of a wax in a large amount is generally known to reduce viscosity during melting and thereby enhance fixability. Furthermore, the releasing effect of the wax can prevent toner from being deposited on a fixing member and suppress the occurrence of negative effects on images, such as offset.

On the other hand, a portion of such a wax used in a large amount tends to reside on the surface of toner particles. In this case, negative effects on images, such as fogs, may occur due to low toner fluidity and reduced friction electrostatic properties. Such negative effects on images frequently occur particularly in the case of using printers or copying machines having a fast printing speed in an environment of high temperature and high humidity stringent for charging.

Approaches of plasticizing a binder resin using a low-molecular-weight wax have been proposed for enhancing fixability (see Japanese Patent Application Laid-Open Nos. H08-050367 and 2006-243714). All of these approaches, however, tend to allow the wax to reside on the surface of toner particles and might fail to overcome negative effects (e.g., fogs) on images for higher-speed printers or copying machines, though the approaches can improve fixability. Use of the wax having a broad melting rate as disclosed in Japanese Patent Application Laid-Open No. 2006-243714 tends to produce variations in the releasability between toner and a fixing member during fixation and might worsen offset.

An approach using a wax having specific composition (see Japanese Patent Application Laid-Open No. H11-133657) has also been proposed. This wax, however, still has room for improvement in low-temperature fixability due to its large molecular weight and high melting point.

Meanwhile, an approach of controlling the deposited state of an external additive has been proposed for improving toner fluidity (see Japanese Patent Application Laid-Open No. 2008-276005). An approach of controlling the deposited state of an external additive while controlling the softening temperature of a binder resin has also been proposed (see Japanese Patent Application Laid-Open No. 2013-156616). Even these approaches, however, still have room for improvement in uniform covering with the external additive and in fluidity resulting from the control of the surface nature of toner particles.

### SUMMARY OF THE INVENTION

The present invention can provide toner that has favorable fixability and releasability and few negative effects (e.g., fogs) on images, irrespective of usage environments.

The present inventors have found that the problems as mentioned above can be solved by using a specific ester wax and controlling the deposited stated of an external additive, leading to the completion of the present invention. Specifically, the present invention is as follows:

Toner including toner particles each containing a binder resin, a colorant and an ester wax, and silica fine particles present on the surface of the toner particles, wherein: the ester wax contains a plurality of esters represented by the following general formula (1) or (2):

R1-COO—(CH₂)ₓ₁—OOC—R2 General formula (1)

R3-OOC—(CH₂)ₓ₂—COO—R4 General formula (2)

wherein R1 to R4 each independently represent an alkyl group having 15 to 26 carbon atoms, and x1 and x2 each independently represent an integer of 8 to 10;
in the composition distribution of the ester wax measured by GC-MASS, (i) when an ester whose content is maximum among the plurality of esters, is designated as “ester A”, a content of the ester A in the ester wax is 40% by mass or larger and 80% by mass or smaller based on the ester wax, and (ii) when a molecular weight of the ester A is represented by M1, a content of an ester having a molecular weight of M1×0.8 or higher and M1×1.2 or lower among the esters contained in the ester wax is 90% by mass or larger based on the ester wax; a coverage ratio X1 of the surface of the toner particles with the silica fine particles determined by electron spectroscopy for chemical analysis (ESCA) is 40.0% by area or more and 75.0% by area or less; and when a theoretical coverage ratio of the surface of the toner particles with the silica fine particles is defined as X2, a diffusion index represented by the following expression (3) satisfies the following expression (4):

Diffusion index=X1/X2 Expression (3)

Diffusion index≧−0.0042×X1+0.62 Expression (4).

The present invention can provide toner that has favorable fixability and releasability and few negative effects (e.g., fogs) on images, irrespective of usage environments.

Further features of the present invention will become apparent from the following description of exemplary embodiments with reference to the attached drawings.

### BRIEF DESCRIPTION OF THE DRAWINGS

FIG. 1 is a diagram illustrating the boundary line of a diffusion index.

FIG. 2 is a schematic diagram illustrating one example of a mixing treatment apparatus that can be used in the external addition and mixing of inorganic fine particles.

FIG. 3 is a schematic diagram illustrating one example of the configuration of a stirring member for use in the mixing treatment apparatus.

FIG. 4 is a diagram illustrating one example of an image forming apparatus.

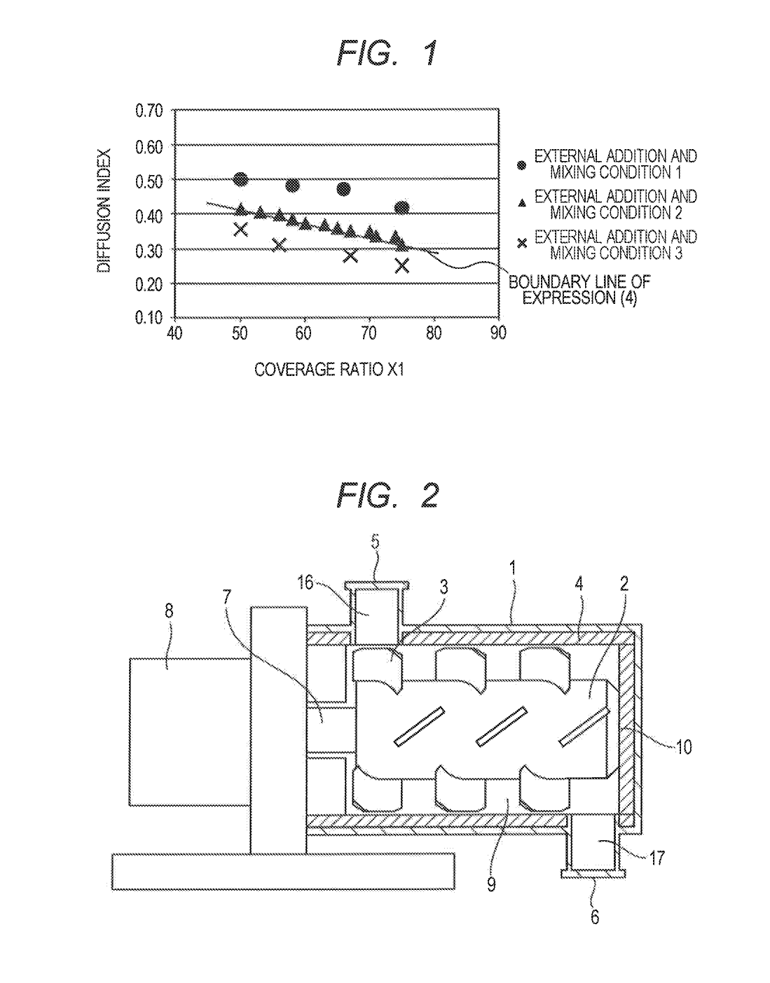

### DESCRIPTION OF THE EMBODIMENTS

Preferred embodiments of the present invention will now be described in detail in accordance with the accompanying drawings.

Toner including toner particles each containing a binder resin, a colorant and an ester wax, and silica fine particles present on the surface of the toner particles, wherein: the ester wax contains a plurality of esters represented by the following general formula (1) or (2):

R1-COO—(CH₂)ₓ₁—OOC—R2 General formula(1)

R3-OOC—(CH₂)ₓ₂—COO—R4 General formula(2)

wherein R1 to R4 each independently represent an alkyl group having 15 to 26 carbon atoms, and x1 and x2 each independently represent an integer of 8 to 10;
in the composition distribution of the ester wax measured by GC-MASS,
(i) when an ester whose content is maximum among the plurality of esters, is designated as “ester A”, a content of the ester A in the ester wax is 40% by mass or larger and 80% by mass or smaller based on the ester wax, and
(ii) when a molecular weight of the ester A is represented by M1, a content of an ester having a molecular weight of M1×0.8 or higher and M1×1.2 or lower among the esters contained in the ester wax is 90% by mass or larger based on the ester wax;
a coverage ratio X1 of the surface of the toner particles with the silica fine particles determined by electron spectroscopy for chemical analysis (ESCA) is 40.0% by area or more and 75.0% by area or less; and when a theoretical coverage ratio of the surface of the toner particles with the silica fine particles is defined as X2, a diffusion index represented by the following expression (3) satisfies the following expression (4):

Diffusion index=X1/X2 Expression (3)

Diffusion index≧−0.0042×X1+0.62 Expression (4).

As a result of conducting diligent studies, the present inventors have found that toner that has favorable fixability and releasability and few negative effects (e.g., fogs) on images can be provided by using a specific ester wax and controlling the deposited state of an external additive.

<General Formula of Ester Wax>

First, the ester wax used in the present invention contains a plurality of esters represented by the following general formula (1) or (2):

R1-COO—(CH₂)ₓ₁—OOC—R2 General formula(1)

R3-OOC—(CH₂)ₓ₂—COO—R4 General formula(2)

wherein R1 to R4 each independently represent an alkyl group having 15 to 26 carbon atoms, and x1 and x2 each independently represent an integer of 8 to 10.

The esters have no branching point in their molecular structures and have a folded conformation close to a straight chain. For this reason, the ester wax can be rapidly molten during fixation because of its easily controllable crystal structure, compared with an ester wax having three or more ester bonds (so-called trifunctional or more ester wax). Also, the ester wax can be prevented from plasticizing the binder resin and also from residing on the surface of the toner particles because of its large molecular weight, compared with an ester wax having only one ester bond (so-called monofunctional ester wax).

The esters represented by the general formula (1) or (2) wherein R1 to R4 each independently represent an alkyl group having 15 to 26 carbon atoms, and x1 and x2 each independently represent an integer of 8 to 10 can readily assume a crystal structure while these esters can be prevented from plasticizing the binder resin.

The studies of the present inventors have revealed that the presence of a wax on the surface of the toner particles reduces toner fluidity. This is due to the technical difficulty in completely shielding the toner particles with an external additive, i.e., controlling a coverage with an external additive at 100%. The presence of a wax on the surface of the toner particles exposed in no small part therefore increases the adhesion among the particles and reduces toner fluidity.

Here, the reason why the reduced toner fluidity causes negative effects (e.g., fogs) on images will be described. For general image output in printers, first, an electrostatic latent image-bearing member (hereinafter, also referred to as a photosensitive member) made of a photoconductive substance is charged using a charging apparatus and further exposed to light to form an electrostatic latent image on the surface of the photosensitive member. Subsequently, the electrostatic latent image is developed with toner on a toner bearing member (hereinafter, also referred to as a development sleeve) to form a toner image. The toner image is transferred to a transfer material such as paper and then fixed onto the transfer material by heat, pressure, or heat and pressure to obtain a duplicate or a print.

During development, the toner on the development sleeve is given a charge by frictional electrification derived from the rub between the development sleeve and a regulating member (hereinafter, referred to as a developing blade). In this process, the low toner fluidity hinders the toner from rolling in the rubbing area between the development sleeve and the developing blade so that the toner is insufficiently charged. Such toner is developed in a non-electrostatic latent image portion of the photosensitive member, resulting in the occurrence of negative effects (e.g., fogs) on images.

As mentioned above, the presence of a wax on the surface of the toner particles is not favorable because fluidity is reduced, facilitating fogging derived from poor charging.

<Content of “Ester A” in Ester Wax Composition>

For the ester wax (hereinafter, also simply referred to as a wax) of the present invention, when an ester whose content is maximum among the plurality of esters, is designated as “ester A”, it is important to have the ester A at a content of 40% by mass or larger and 80% by mass or smaller based on the ester wax when measured by GC-MASS. The ester wax having the ester A at a content of 40% by mass or larger and 80% by mass or smaller means that the ester wax has composition distribution. As an example, the composition of the ester wax used in the toner of the present invention is shown in Table 1. The ester wax of the present invention can have various compositions as shown in Table 1. Thus, it is important to control the content of the most abundant component.

When a molecular weight of the ester A in the ester wax is represented by M1, the content of an ester having a molecular weight of M1×0.8 or higher and M1×1.2 or lower among the esters contained in the ester wax is 90% by mass or larger based on the ester wax. This means that the ester wax contains an ester having an excessively high molecular weight or an ester having an excessively low molecular weight only in a small amount.

A small-molecular-weight wax capable of plasticizing a binder resin is known to be effective for improving low-temperature fixability. Such a wax, however, tends to exude to the surface of toner particles and might thus reduce toner fluidity. By contrast, the wax composition controlled as described above can improve fixability with toner fluidity maintained.

This is presumably because the wax having the composition distribution as mentioned above can assume a loose crystal structure in the toner particles. Specifically, a compatible layer of the wax and the binder resin is formed at the interface between the wax and the binder resin, compared with a wax having no composition distribution. This layer can promote the plasticization of the binder resin during fixation and improve low-temperature fixation.

A wax having the ester A at a content smaller than 40% by mass is not favorable because its compatibility with the binder resin is accelerated so that the wax exudes to the surface of the toner particles, resulting in reduced toner fluidity. Alternatively, a wax having the ester A at a content exceeding 80% by mass is less likely to promote the plasticization of the binder resin during fixation and is therefore less effective for low-temperature fixability.

When a molecular weight of the ester A is represented by M1, the content of an ester having a molecular weight of M1×0.8 or higher and M1×1.2 or lower is adjusted to 90% by mass or larger with respect to the total amount of the ester wax. The resultant wax is easily crystallized. In addition, the amount of a component compatible with the binder resin is also reduced. As a result, toner fluidity can be secured.

The molten state of the wax can be highly controlled as mentioned above to thereby improve toner fixability and secure toner fluidity.

The ester wax that can be used in the toner of the present invention is a bifunctional ester wax represented by the general formula (1) or (2) and is specifically a compound obtained by reacting between a dicarboxylic acid and mono-alcohol or between a diol and a mono-carboxylic acid. Examples of the dicarboxylic acid include decanedioic acid and dodecanedioic acid. Examples of the diol include 1,8-octanediol, 1,9-nonanediol and 1,10-decanediol. In the general formula (1) or (2), each of R1 to R4 is independently an alkyl group having 15 to 26 carbon atoms. Specific examples of the mono-carboxylic acid and the mono-alcohol include: fatty acids such as palmitic acid, margaric acid, stearic acid, tuberculostearic acid, arachidic acid, behenic acid, lignoceric acid and cerotinic acid; and aliphatic alcohols such as pentadecanol, hexadecanol, heptadecanol, octadecanol, nonadecanol, eicosanol, docosanol, tricosanol, tetracosanol, pentacosanol and hexacosanol.

<Coverage Ratio X1 with Silica Fine Particles>

In the toner of the present invention, the coverage ratio X1 of the surface of the toner particles with the silica fine particles determined by electron spectroscopy for chemical analysis (ESCA) is 40.0% by area or more and 75.0% by area or less. The coverage ratio X1 can be calculated from the ratio of the detection intensity of Si elements measured in the toner to the detection intensity of Si elements measured in the silica fine particles alone by ESCA. This coverage ratio X1 represents the proportion of an area actually covered with the silica fine particles to the whole surface of the toner particles.

The coverage ratio X1 of 40.0% by area or more and 75.0% by area or less can control toner fluidity and electrostatic properties in favorable ranges. A coverage ratio X1 less than 40.0% by area cannot produce sufficient fluidity because a large proportion of the surface of the toner particles is exposed.

<Diffusion Index>

When a theoretical coverage ratio of the surface of the toner particles with the silica fine particles is defined as X2, it is important for a diffusion index represented by the following expression (3) to satisfy the following expression (4):

Diffusion index=X1/X2 Expression (3)

Diffusion index≧−0.0042×X1+0.62 Expression (4).

The theoretical coverage ratio X2 is calculated according to the expression (5) given below using, for example, the number of parts by mass of the silica fine particles with respect to 100 parts by mass of the toner particles, and the particle size of the silica fine particles. This coverage ratio X2 represents the proportion of a theoretically coverable area to the surface of the toner particles.

Theoretical coverage ratio X2(% by area)=3^{1/2}/(2π)×(dt/da)×(ρt/ρa)×C×100 Expression (5)

da: number-average particle size (D1) of the silica fine particles
dt: weight-average particle size (D4) of the toner particles
ρa: true specific gravity of the silica fine particles
ρt: true specific gravity of the toner
C: mass of the silica fine particles/mass of the toner
(The content of the silica fine particles in the toner mentioned later is used as C.)

Hereinafter, the physical implications of the diffusion index represented by the expression (3) will be described.

The diffusion index represents an alienation between the actually measured coverage ratio X1 and the theoretical coverage ratio X2. The degree of this alienation is considered to indicate the amount of silica fine particles multilayered (e.g., 2-layered or 3-layered) in the vertical direction on the surface of the toner particles. Ideally, the diffusion index is 1. In this case, however, the coverage ratio X1 is equal to the theoretical coverage ratio X2. This means that the multilayered (2- or more layered) silica fine particles are absent. By contrast, when the silica fine particles are present as aggregated secondary particles on the surface of the toner particles, the alienation occurs between the actually measured coverage ratio and the theoretical coverage ratio, resulting in a low diffusion index.

In short, the diffusion index can be interchanged with an index for the amount of the silica fine particles present as secondary particles. It is important for the diffusion index according to the present invention to fall within the range represented by the expression (4). This range seems to be larger than that of toner produced by a conventional technique. The larger diffusion index indicates that the silica fine particles on the surface of the toner particles are present as a smaller amount of secondary particles and as a larger amount of primary particles. This means that the surface of the toner particles is uniformly covered with the silica fine particles, only a few of which are in the form of aggregates. As mentioned above, the upper limit of the diffusion index is 1.

The expression (4) represents a suitable range of the diffusion index according to the present invention. The diffusion index is a function of the variable coverage ratio X1 in the range of 40.0% by area or more and 75.0% by area or less. The calculation of this function is obtained empirically from results of evaluating low-temperature fixability and fogs when the coverage ratio X1 and the diffusion index are determined with the silica fine particles, external addition conditions, etc. varied.

In the present invention, the structure and composition of the wax can be controlled as described above such that the coverage ratio X1 is 40.0% by area or more and 75.0% by area or less and the diffusion index satisfies the expression (4). When these requirements are met, the releasability between the toner and a fixing member during fixation has been found to be largely improved. This improving effect is brought about by the combined events in which: the wax that maintains its crystal structure is rapidly molten during fixation; and the silica fine particles covering the surface of the toner particles are uniformly dispersed as primary particles. This is probably because the wax exudes evenly at once to the surface of the toner particles during fixation.

In general, toner transferred to paper is fixed onto the paper under heat and pressure by a fixing member. If the paper has large surface asperities, adequate pressure is not applied to toner particles positioned in the depressed portions. In this case, the wax fails to exude to the surface of the toner particles. The resultant toner tends to contaminate the fixing member due to insufficient releasability and thereby cause offset (hereinafter, referred to as low-temperature offset). As mentioned above, the structure and composition of the wax can be controlled such that the coverage ratio X1 is 40.0% by area or more and 75.0% by area or less and the diffusion index satisfies the expression (4). In this respect, favorable resistance to low-temperature offset can be obtained even when paper having large surface asperities is used.

The occurrence of such low-temperature offset is also influenced by the spattering of toner on an image forming member. The toner particles that have spattered are isolated from the toner layer on the image forming member and do not receive adequate pressure during fixation. Still, the low-temperature offset occurs easily. The toner of the present invention maintains its high fluidity resulting from the control of the wax and the externally added state of the silica fine particles and as such, can be uniformly charged in a developing member. For this reason, a latent image on the photosensitive member is developed with a high degree of reproducibility. Therefore, the toner rarely spatters and, consequently, can yield favorable resistance to low-temperature offset.

When the diffusion index falls within a range represented by the expression (6) given below, the silica fine particles are present as an increased amount of secondary particles and have low covering uniformity, resulting in poor resistance to low-temperature offset.

Diffusion index<−0.0042×X1+0.62 Expression (6)

<Ester Wax Content>

The toner of the present invention can preferably contain 5 parts by mass or larger and 20 parts by mass or smaller of the ester wax with respect to 100 parts by mass of the binder resin. The wax having the content of 5 parts by mass or larger produces favorable low-temperature fixability. The wax having the content of 20 parts by mass or smaller neither exudes to the surface of the toner particles nor causes reduction in fluidity.

The toner of the present invention preferably has a glass transition temperature Tg1 of 46° C. or higher and 60° C. or lower in a first heating process when measured using a differential scanning calorimeter (DSC), and preferably has a 10° C. or more difference (Tg2−Tg1) of a glass transition temperature Tg2 in a second heating process from the glass transition temperature Tg1 when measured after subsequent cooling followed by reheating. The 10° C. or more difference Tg2−Tg1 means that the wax assumes a crystal structure with a low level of compatibility with the binder resin. Thus, favorable toner fluidity can be obtained.

The wax used in the toner of the present invention seems to assume a loose crystal structure, as mentioned above, owing to the highly controlled structure and composition of the wax. The degree of crystallinity of the wax can also be controlled by the following method for producing toner.

Specifically, the production method includes the steps of heat-treating toner under conditions of (Step a) and (Step b). (Step a) is performed prior to (Step b).

(Step a) Step of performing heat treatment in the presence of the binder resin and the wax for 60 minutes or longer at a temperature that is higher by at least 10° C. than the end temperature of wax melting when measured using a differential scanning calorimeter.
(Step b) Step of performing heat treatment for 60 minutes or longer at a temperature that falls within the temperature range of an exothermic peak derived from wax crystallization and satisfies a 4.0° C. or less range of temperature fluctuations centered on a temperature lower than the start temperature of wax melting when measured using a differential scanning calorimeter.

The toner produced through these steps can have a large difference Tg2−Tg1 and a high degree of crystallinity of the wax.

This is presumably because in (Step a) in the toner production, the wax and the binder resin are crystallized after being mutually blended at an adequate level to thereby be likely to form various sizes of crystals, compared with the crystallization of the wax alone. For controlling the crystal size of the wax in (Step b), it may also be required that the wax should be temporarily molten thoroughly in (Step a). The subsequent heat treatment under the temperature conditions of (Step b) can promote the crystallization of the wax.

In general, the crystallization of the wax occurs by the heat treatment within the temperature range of an exothermic peak derived from the crystallization. However, heat treatment within the temperature range where the wax is molten must be avoided because the crystallized wax is also molten.

The heat treatment steps need to be performed in the presence of the binder resin and the wax. Thus, for the production by a suspension polymerization method, the heat treatment steps are performed in a state where the rate of polymerization is preferably 80% or more, more preferably 95% or more. The heat treatment steps are not particularly limited as long as the steps are performed in the presence of the binder resin and the wax. In the case of producing the toner by a dry process, (Step a) may be performed, for example, during or after melt blending. (Step b) may be performed following (Step a) or may be performed after, for example, coarse cracking, pulverization or external addition, as long as (Step b) is performed after (Step a).

In the case of producing the toner by a wet process, (Step a) may be performed, for example, during or after reaction. (Step b) may be performed following (Step a) or may be performed during drying or as a subsequent step, as long as (Step b) is performed after (Step a). In the wet-process production method, (Step a) can be performed in a dispersed state of the toner in a dispersion medium from the viewpoint of preventing fusion bonding.

The ester wax used in the present invention has a melting point of 65° C. or higher and 85° C. or lower. The melting point of 65° C. or higher can neither reduce the degree of crystallinity in the toner nor worsen preservative quality or developability. The melting point of 85° C. or lower can prevent the fixation temperature of the toner from becoming high.

The weight-average particle size (D4) of the toner of the present invention is preferably 3 μm or larger and 12 μm or smaller, more preferably 4 μm or larger and 9 μm or smaller, for developing very small latent image dots with high fidelity in order to achieve high image quality. The individual particles of toner having a weight-average particle size (D4) smaller than 3 μm are difficult to charge uniformly due to reduced fluidity and stirring properties as a powder. On the other hand, a weight-average particle size (D4) larger than 12 μm is not favorable because the weight-average particle size (D4) favorably suppresses fogging but reduces dot reproducibility.

The average circularity of the toner of the present invention can be 0.950 or higher. The average circularity of 0.950 or higher is favorable because the toner having such a circularity tends to have a (nearly) spherical shape and have excellent fluidity and uniform friction electrostatic properties.

Examples of the binder resin that can be used in the toner of the present invention include: homopolymers of styrene and its substitution products, such as polystyrene and polyvinyltoluene; styrene copolymers such as styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-dimethylaminoethyl acrylate copolymers, styrene-methyl methacrylate copolymers, styrene-ethyl methacrylate copolymers, styrene-butyl methacrylate copolymers, styrene-dimethylaminoethyl methacrylate copolymers, styrene-vinyl methyl ether copolymers, styrene-vinyl ethyl ether copolymers, styrene-vinyl methyl ketone copolymers, styrene-butadiene copolymers, styrene-isoprene copolymers, styrene-maleic acid copolymers and styrene-maleic acid ester copolymers; and other resins such as polymethyl methacrylate, polybutyl methacrylate, polyvinyl acetate, polyethylene, polypropylene, polyvinylbutyral, silicone resins, polyester resins, polyamide resins, epoxy resins and polyacrylic acid resins. These binder resins can be used singly or in combinations of two or more. Among these binder resins, a styrene copolymer or a polyester resin is particularly preferred in terms of development characteristics, fixability, etc.

In the toner of the present invention, a charge control agent may be contained, if necessary, in the toner particles. The charge control agent contained therein can stabilize charge characteristics and control a friction electrostatic amount optimal for a development system.

A charge control agent known in the art can be used. The charge control agent is preferably a charge control agent that has a fast charging speed and can stably maintain a constant charge amount. In the case of producing the toner particles by a direct polymerization method, the charge control agent is particularly preferably a charge control agent that is less capable of inhibiting polymerization and is substantially free from a component soluble in an aqueous medium. The content of the charge control agent is preferably 0.3 parts by mass or larger and 10.0 parts by mass or smaller, more preferably 0.5 parts by mass or larger and 8.0 parts by mass or smaller, with respect to 100 parts by mass of a polymerizable monomer or the binder resin.

The toner of the present invention contains a colorant.

Examples of the colorant that can be used in the present invention are given below.

Examples of organic pigments or organic dyes as cyan colorants include copper phthalocyanine compounds and their derivatives, anthraquinone compounds and basic dye lake compounds.

Examples of organic pigments or organic dyes as magenta colorants include condensed azo compounds, diketopyrrolopyrrole compounds, anthraquinone, quinacridone compounds, basic dye lake compounds, naphthol compounds, benzimidazolone compounds, thioindigo compounds and perylene compounds.

Examples of organic pigments or organic dyes as yellow colorants include compounds typified by condensed azo compounds, isoindolinone compounds, anthraquinone compounds, azo-metal complexes, methine compounds and allylamide compounds.

Examples of black colorants include carbon black, and black toned colorants with using the yellow colorants, magenta colorants and cyan colorants described above.

In the case of using the colorant, the colorant can be added in an amount of 1 part by mass or larger and 20 parts by mass or smaller with respect to 100 parts by mass of the polymerizable monomer or the binder resin.

The toner of the present invention may contain a magnetic material. In the present invention, the magnetic material can also function as a colorant.

The magnetic material used in the present invention is composed mainly of, for example, ferrosoferric oxide or γ-ferric oxide and may contain an element such as phosphorus, cobalt, nickel, copper, magnesium, manganese or aluminum. The magnetic material has a shape such as a polyhedral, octahedral, hexahedral, spherical, needle-like or scale-like shape. Among these magnetic materials, a less anisotropic magnetic material (e.g., polyhedral, octahedral, hexahedral or spherical material) is preferred for enhancing an image density. The content of the magnetic material according to the present invention can be 50 parts by mass or larger and 150 parts by mass or smaller with respect to 100 parts by mass of the polymerizable monomer or the binder resin.

The toner of the present invention can have a core/shell structure whose core layer contains a styrene-acrylic resin and whose shell layer contains amorphous polyester resin. In the present invention, the core/shell structure refers to a structure in which the surface of the core layer is covered with the shell layer. The toner having such a core/shell structure whose core layer contains a styrene-acrylic resin and whose shell layer contains an amorphous polyester resin can exhibit favorable rising of charge and have better durability.

The toner of the present invention may be produced by any method known in the art and can be obtained by the production of the toner particles in an aqueous medium. In the case of producing the toner by a pulverization method, components necessary for the toner, for example, the binder resin, the colorant, the ester wax and the charge control agent, and other additives are thoroughly mixed using a mixing machine such as a Henschel mixer or a ball mill.

Thereafter, the toner materials are dispersed or dissolved by melt kneading using a thermal kneading machine such as a heat roll, a kneader or an extruder. After cool solidification and pulverization, the resultant powder can be classified and, if necessary, surface-treated to obtain toner particles. The classification and the surface treatment may be performed in any order. A multiclass classifier can be used in the classification step in light of production efficiency.

The pulverization step can be performed by a method using a pulverization apparatus known in the art such as mechanical impact type or jet type. For obtaining the toner having the suitable circularity of the present invention, the pulverization can be conducted thermally or combined with auxiliary treatment for the application of mechanical impact. Alternatively, a hot-water bath method of dispersing the pulverized (and, if necessary, classified) toner particles in hot water, a method of allowing these toner particles to pass through thermal air current, or the like may be used.

Examples of units for the application of mechanical impact power include methods using a mechanical impact-type pulverizer such as Kryptron System manufactured by Kawasaki Heavy Industries, Ltd. or Turbo Mill manufactured by Freund-Turbo Corporation. Other examples thereof include methods of pressing the toner against the inside of a casing through centrifugal force using a high-speed rotary blade of the following apparatus to thereby applying mechanical impact power based on force such as compressive force or frictional force to the toner: Mechanofusion System manufactured by Hosokawa Micron Ltd. Hybridization System manufactured by Nara Machinery Co., Ltd.

The toner of the present invention may be produced, as mentioned above, by the pulverization method. The toner particles obtained by this pulverization method, however, are generally non-uniform shape. Accordingly, for the toner of the present invention, the toner particles are preferably produced in an aqueous medium by, for example, a dispersion polymerization method, an associative aggregation method, a dissolution suspension method or a suspension polymerization method and particularly preferably produced by a suspension polymerization method because the resultant toner tends to satisfy the suitable physical properties of the present invention.

In the suspension polymerization method, the polymerizable monomer, the colorant and the wax (and, if necessary, a polymerization initiator, a cross-linking agent, a charge control agent and other additives) are uniformly dissolved or dispersed to obtain a polymerizable monomer composition. Then, this polymerizable monomer composition is dispersed into a continuous layer (e.g., an aqueous phase) containing a dispersant using an appropriate stirrer, while polymerization reaction is performed to obtain toner particles having the desired particle size. The individual particles of the toner thus obtained by the suspension polymerization method (hereinafter, also referred to as “polymerized toner”) commonly have a substantially spherical shape. Thus, the toner particles have relatively uniform distribution of charge amounts and can therefore be expected to have better image quality.

Examples of the polymerizable monomer constituting the polymerizable monomer composition in the production of the polymerized toner according to the present invention are given below.

Examples of the polymerizable monomer include: styrene monomers such as styrene, o-methylstyrene, m-methylstyrene, p-methylstyrene, p-methoxystyrene and p-ethylstyrene; acrylic acid esters such as methyl acrylate, ethyl acrylate, n-butyl acrylate, isobutyl acrylate, n-propyl acrylate, n-octyl acrylate, dodecyl acrylate, 2-ethylhexyl acrylate, stearyl acrylate, 2-chloroethyl acrylate and phenyl acrylate; methacrylic acid esters such as methyl methacrylate, ethyl methacrylate, n-propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate and diethylaminoethyl methacrylate; and other monomers such as acrylonitrile, methacrylonitrile and acrylamide. These monomers can be used singly or as a mixture. Among these monomers, styrene or a styrene derivative is preferably used alone or as a mixture with any of other monomers in terms of the development characteristics and durability of the toner.

The polymerization initiator used in the production of the toner of the present invention by the polymerization method can have a half-life of 0.5 to 30 hours during polymerization reaction. The polymerization initiator can be added in an amount of 0.5 to 20 parts by mass with respect to 100 parts by mass of the polymerizable monomer and used in polymerization reaction to obtain a polymerization product having a peak molecular weight between 5,000 and 50,000, which imparts favorable strength and appropriate melting characteristics to the toner.

Specific examples of the polymerization initiator include: azo or diazo polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile and azobisisobutyronitrile; and peroxide polymerization initiators such as benzoyl peroxide, methyl ethyl ketone peroxide, diisopropyl peroxycarbonate, cumene hydroperoxide, 2,4-dichlorobenzoyl peroxide, lauroyl peroxide, t-butyl peroxy-2-ethylhexanoate and t-butyl peroxypivalate.

For the production of the toner of the present invention by the polymerization method, a cross-linking agent may be added. The amount of the cross-linking agent added can be 0.001 to 15 parts by mass with respect to 100 parts by mass of the polymerizable monomer.

In this context, a compound having two or more polymerizable double bonds is mainly used as the cross-linking agent. For example, aromatic divinyl compounds (e.g., divinylbenzene and divinylnaphthalene), carboxylic acid esters having two double bonds (e.g., ethylene glycol diacrylate, ethylene glycol dimethacrylate and 1,3-butanediol dimethacrylate), divinyl compounds (e.g., divinylaniline, divinyl ether, divinyl sulfide and divinylsulfone) and compounds having 3 or more vinyl groups are used singly or as a mixture of two or more.

The method for producing the toner of the present invention by the polymerization method generally involves appropriately adding the toner composition mentioned above and the like, uniformly dissolving or dispersing the composition using a dispersing machine such as a homogenizer, a ball mill or an ultrasonic disperser, and suspending the resultant polymerizable monomer composition in an aqueous medium containing a dispersant. In this case, the toner particles may be prepared into the desired size at once using a high-speed stirrer or a high-speed disperser such as an ultrasonic disperser. The toner particles thus obtained have a sharp particle size. The polymerization initiator may be added simultaneously with the addition of other additives into the polymerizable monomer or may be mixed immediately before the suspension in the aqueous medium. Alternatively, the polymerizable monomer or the polymerization initiator dissolved in a solvent may be added immediately after granulation and before the start of polymerization reaction.

After the granulation, the particles may be stirred using an ordinary stirrer to such a degree that the particle state is maintained while the floating or precipitation of the particles is inhibited.

For the production of the toner of the present invention, a surfactant, an organic dispersant or an inorganic dispersant known in the art can be used as the dispersant. Among these dispersants, an inorganic dispersant can be preferably used because the inorganic dispersant rarely yields harmful ultrafine powders and produces dispersion stability based on its steric hindrance; thus the stability is less likely to be disrupted even at varying reaction temperatures, and because the inorganic dispersant can be readily washed off without adversely affecting the toner. Examples of such inorganic dispersants include: phosphoric acid polyvalent metal salts such as tricalcium phosphate, magnesium phosphate, aluminum phosphate, zinc phosphate and hydroxyapatite; carbonates such as calcium carbonate and magnesium carbonate; inorganic salts such as calcium metasilicate, calcium sulfate and barium sulfate; and inorganic compounds such as calcium hydroxide, magnesium hydroxide and aluminum hydroxide.

The inorganic dispersant can be used in an amount of 0.2 to 20 parts by mass with respect to 100 parts by mass of the polymerizable monomer.

After the completion of the polymerization of the polymerizable monomer, the obtained polymerization product particles are filtered, washed and dried by methods known in the art to obtain toner particles. The toner particles thus obtained are mixed with the silica fine particles and, if necessary, a fine powder as mentioned later to thereby deposit the silica fine particles on the surface of the toner particles. In this way, the toner of the present invention can be obtained. Alternatively, the production process (before mixing of the silica fine particles and the fine powder) may further involve a classification step which can cut off coarse powders or fine powders from the toner particles.

The toner of the present invention may be supplemented with particles having a number-average particle size (D1) of 80 nm or larger and 3 μm or smaller as primary particles (fine powder), in addition to the silica fine particles. For example, a lubricant (e.g., fluorine resin powders, zinc stearate powders and polyvinylidene fluoride powders), an abrasive (e.g., cerium oxide powders, silicon carbide powders and strontium titanate powders), and/or spacer particles (e.g., silica) may be used in small amounts without influencing the effects of the present invention.

A mixing treatment apparatus known in the art can be used as a mixing treatment apparatus for the external addition and mixing of the silica fine particles. An apparatus as illustrated in FIG. 2 can be used because the coverage ratio X1 and the diffusion index can be easily controlled.

FIG. 2 is a schematic diagram illustrating one example of a mixing treatment apparatus that can be used in the external addition and mixing of the silica fine particles used in the present invention.

The mixing treatment apparatus is configured such that shear is applied to the toner particles and the silica fine particles in an area of narrow clearance. The silica fine particles can therefore be deposited on the surface of the toner particles while broken up from secondary particles into primary particles.

As mentioned later, the coverage ratio X1 and the diffusion index are easily controlled in ranges suitable for the present invention because the toner particles and the silica fine particles readily circulate in the axial direction of a rotator and are readily mixed thoroughly and uniformly before the progression of fixing.

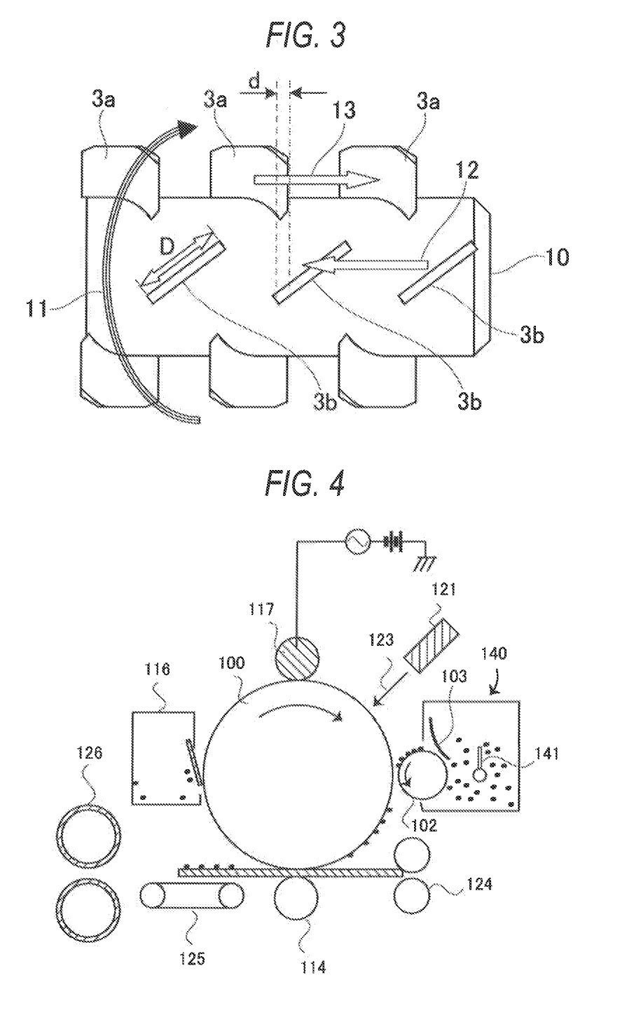

FIG. 3 is a schematic diagram illustrating one example of the configuration of a stirring member for use in the mixing treatment apparatus.

Hereinafter, the external addition and mixing process for the silica fine particles will be described with reference to FIGS. 2 and 3.

The mixing treatment apparatus for the external addition and mixing of the silica fine particles at least has a rotator 2 with a plurality of stirring members 3 disposed on its surface, a driving member 8 which drives the rotation of the rotator, and a main casing 1 disposed to have a gap with the stirring members 3.

It is important to keep the gap (clearance) between the inner periphery of the main casing 1 and the stirring members 3 constant and very small, for uniformly applying shear to the toner particles and facilitating depositing the silica fine particles on the surface of the toner particles while breaking up the silica fine particles from secondary particles into primary particles.

In this apparatus, the diameter of the inner periphery of the main casing 1 is twice or smaller the diameter of the outer periphery of the rotator 2. FIG. 2 illustrates an example in which the diameter of the inner periphery of the main casing 1 is 1.7 times the diameter of the outer periphery of the rotator 2 (diameter of the body of the rotator 2 except for the stirring members 3). When the diameter of the inner periphery of the main casing 1 is twice or smaller the diameter of the outer periphery of the rotator 2, the treatment space where force acts on the toner particles is moderately restricted so that impact force is sufficiently applied to the silica fine particles in the form of secondary particles.

It is also important to adjust the clearance according to the size of the main casing. The clearance is set to approximately 1% or more and approximately 5% or less of the diameter of the inner periphery of the main casing 1. This is important because sufficient shear can be applied to the silica fine particles. Specifically, when the inner periphery of the main casing 1 has a diameter on the order of 130 mm, the clearance may be set to approximately 2 mm or larger and approximately 5 mm or smaller. When the inner periphery of the main casing 1 has a diameter on the order of 800 mm, the clearance may be set to approximately 10 mm or larger and approximately 30 mm or smaller.

The external addition and mixing process for the silica fine particles according to the present invention employs the mixing treatment apparatus and involves rotating the rotator 2 by the driving member 8 and stirring and mixing the toner particles and the silica fine particles introduced into the mixing treatment apparatus to complete the external addition and mixing treatment of the silica fine particles to the surface of the toner particles.

As illustrated in FIG. 3, at least some of the plurality of stirring members 3 are provided as forward stirring members 3a which feed forward the toner particles and the silica fine particles in the axial direction of the rotator, with the rotation of the rotator 2. Also, at least some of the plurality of stirring members 3 are provided as backward stirring members 3b which feed backward the toner particles and the silica fine particles in the axial direction of the rotator, with the rotation of the rotator 2.

In the case of the main casing 1 provided at both ends with a raw material inlet 5 and a product outlet 6, respectively, as illustrated in FIG. 2, the direction from the raw material inlet 5 toward the product outlet 6 (direction toward the right in FIG. 2) is referred to as a “forward direction”.

Specifically, as illustrated in FIG. 3, the plate surfaces of the forward stirring members 3a are inclined so as to feed the toner particles and the silica fine particles in the forward direction 13. On the other hand, the plate surfaces of the stirring members 3b are inclined so as to feed the toner particles and the silica fine particles in the backward direction 12.

As a result, the external addition and mixing treatment of the silica fine particles to the surface of the toner particles is performed while feed in the “forward direction” 13 and feed in the “backward direction” 12 are repetitively performed.

The stirring members 3a and 3b are formed as sets each involving a plurality of members 3a or 3b arranged at intervals in the circumferential direction of the rotator 2. In the example illustrated in FIG. 3, the stirring members 3a and 3b are formed as sets each involving two members 3a or 3b mutually arranged at an interval of 180 degrees on the rotator 2. Alternatively, a larger number of members may form one set, such as three members arranged at intervals of 120 degrees or four members arranged at intervals of 90 degrees.

In the example illustrated in FIG. 3, a total of 12 equally spaced stirring members 3a and 3b are formed.

In FIG. 3, D represents the width of each stirring member, and d represents a distance that indicates the overlap between the stirring members. The width represented by D can be approximately 20% or more and approximately 30% or less of the length of the rotator 2 in FIG. 3 from the viewpoint of efficiently feeding the toner particles and the silica fine particles in the forward direction and in the backward direction. In FIG. 3, the width represented by D is 23% of the length of the rotator 2. The stirring members 3a and 3b can have some degree of the overlap d between each stirring member 3a and each stirring member 3b, when a line is extended vertically from one end of the stirring member 3a. This enables shear to be efficiently applied to the silica fine particles in the form of secondary particles. The ratio of d to D can be 10% or more and 30% or less in terms of the application of shear.

The shape of the stirring blade may be the shape as illustrated in FIG. 3 as well as a shape having a curved surface or a paddle structure in which the tip of the blade is connected to the rotator 2 through a rod-shaped arm, as long as the toner particles can be fed in the forward direction and in the backward direction and the clearance can be maintained.

Hereinafter, the present invention will be described in more detail with reference to the schematic diagrams of the apparatus illustrated in FIGS. 2 and 3. The apparatus illustrated in FIG. 2 at least has a rotator 2 with a plurality of stirring members 3 disposed on its surface, a driving member 8 which drives the rotation of the rotator 2 around a central axis 7, a main casing 1 disposed to have a gap with the stirring members 3, and a jacket 4. The jacket 4 is disposed on the inside of the main casing 1 and a side surface 10 of the end of the rotator and permits flow of a cooling and heating medium.

The apparatus illustrated in FIG. 2 further has a raw material inlet 5 disposed at the top of the main casing 1, and a product outlet 6 disposed at the bottom of the main casing 1. The raw material inlet 5 is used for introducing the toner particles and the silica fine particles. The product outlet 6 is used for discharging the toner after external addition and mixing treatment from the main casing 1.

In the apparatus illustrated in FIG. 2, an inner piece 16 for a raw material inlet is inserted in the raw material inlet 5, and an inner piece 17 for a product outlet is inserted in the product outlet 6.

In the present invention, first, the inner piece for a raw material inlet is removed from the raw material inlet 5, and the toner particles are introduced into a treatment space 9 from the raw material inlet 5. Next, the silica fine particles are introduced into the treatment space 9 from the raw material inlet 5, and the inner piece 16 for a raw material inlet is inserted into the raw material inlet 5. Next, the rotator 2 is rotated by the driving member 8 (reference numeral 11 denotes the direction of rotation) to perform external addition and mixing treatment while stirring and mixing the introduced materials to be treated using a plurality of stirring members 3 disposed on the surface of the rotator 2.

The order in which the raw materials are introduced may begin with the introduction of the silica fine particles from the raw material inlet 5 followed by the introduction of the toner particles from the raw material inlet 5. Alternatively, the toner particles and the silica fine particles may be mixed in advance using a mixing machine such as a Henschel mixer, and the resultant mixture can then be introduced from the raw material inlet 5 of the apparatus illustrated in FIG. 2.

More specifically, as conditions for the external addition and mixing treatment, the power of the driving member 8 can be adjusted to 0.2 W/g or larger and 2.0 W/g or smaller for obtaining the coverage ratio X1 and the diffusion index stipulated by the present invention. The power of the driving member 8 is more preferably adjusted to 0.6 W/g or larger and 1.6 W/g or smaller.

A power lower than 0.2 W/g is less likely to increase the coverage ratio X1 and tends to render the diffusion index too low. On the other hand, a power higher than 2.0 W/g tends to cause the silica fine particles to be buried too much in the toner particles, though increasing the diffusion index.

The treatment time is not particularly limited and can be 3 minutes or longer and 10 minutes or shorter. A treatment time shorter than 3 minutes tends to decrease the coverage ratio X1 and the diffusion index.

The rotational speed of the stirring members during external addition and mixing is not particularly limited. When the apparatus illustrated in FIG. 2 has a volume of the treatment space 9 of 2.0×10⁻³ m³ and has the stirring members 3 shaped as illustrated in FIG. 3, the rotational speed of the stirring members can be 800 rpm or higher and 3000 rpm or lower. The coverage ratio X1 and diffusion index stipulated by the present invention can be easily obtained at the rotational speed of 800 rpm or higher and 3000 rpm or lower.

In the present invention, a particularly preferred treatment method further includes a premixing step before the external addition and mixing process. Such an additional premixing step facilitates uniformly dispersing the silica fine particles at high levels on the surface of the toner particles, resulting in a high coverage ratio X1 and further a high diffusion index.

More specifically, as conditions for the premixing treatment, the power of the driving member 8 can be set to 0.06 W/g or larger and 0.20 W/g or smaller, and the treatment time can be set to 0.5 minutes or longer and 1.5 minutes or smaller. Under premixing treatment conditions involving a load power lower than 0.06 W/g or a treatment time shorter than 0.5 minutes, thorough and uniform mixing is rarely achieved as premixing. On the other hand, under premixing treatment conditions involving a load power higher than 0.20 W/g or a treatment time longer than 1.5 minutes, the silica fine particles may be fixed to the surface of the toner particles before thorough and uniform mixing.

When the apparatus illustrated in FIG. 2 has a volume of the treatment space 9 of 2.0×10⁻³ m³ and has the stirring members 3 shaped as illustrated in FIG. 3, the rotational speed of the stirring members in the premixing treatment can be 50 rpm or higher and 500 rpm or lower. The coverage ratio X1 and diffusion index stipulated by the present invention can be easily obtained at the rotational speed of 50 rpm or higher and 500 rpm or lower.

After the completion of the external addition and mixing treatment, the inner piece 17 for a product outlet is removed from the product outlet 6. The rotator 2 is rotated by the driving member 8 to discharge the toner from the product outlet 6. If necessary, coarse particles are separated from the obtained toner using a screen such as a circular vibrating screen to obtain toner.

Next, one example of an image forming apparatus in which the toner of the present invention can be suitably used will be described specifically with reference to FIG. 4. In FIG. 4, reference numeral 100 denotes an electrostatic latent image-bearing member (hereinafter, also referred to as a photosensitive member) which is provided at its periphery with a roller-shaped charging member (charging roller) 117, a developing unit 140 having a toner bearing member 102, a roller-shaped transfer member (transfer roller) 114, a cleaner container 116, a fixing member 126, a pickup roller 124, and the like.

The developing unit 140 has a rotatably disposed stirring member 141 which stirs toner contained therein, the toner bearing member 102 which has magnetic poles and carries toner for developing an electrostatic latent image on an electrostatic latent image-bearing member, and a toner-regulating member 103 which regulates the amount of toner on the toner bearing member 102.

The electrostatic latent image-bearing member 100 is charged by the charging roller 117. Then, the electrostatic latent image-bearing member 100 is irradiated with laser beam 123 by a laser generation apparatus 121 for light exposure to form an electrostatic latent image corresponding to the desired image. The electrostatic latent image on the electrostatic latent image-bearing member 100 is developed with single-component toner by the developing unit 140 to obtain a toner image. The toner image is transferred onto a transfer material by the transfer roller 114 contacted with the electrostatic latent image-bearing member via the transfer material. The transfer material with the toner image placed thereon is transported via a conveyor belt 125 to the fixing member 126 where the toner image is fixed onto the transfer material. Also, toner remnants on the electrostatic latent image-bearing member are scraped off by a cleaning blade and held in the cleaner container 116.

Next, a method for measuring each physical property according to the present invention will be described.

<Measurement of Molecular Weight and Composition Distribution of Ester Wax>

The composition distribution of the ester wax is calculated by determining the peak area of each component using gas chromatography (GC) and determining the ratio thereof to the total peak area.

Specifically, GC-17A (manufactured by Shimadzu Corporation) is used for the gas chromatography (GC). 10 mg of each sample is added to 1 mL of toluene and dissolved by heating for 20 minutes in a thermostat bath of 80° C. Subsequently, 1 μL of this solution is injected to a GC apparatus equipped with an on-column injector. The column used is Ultra Alloy-1 (HT) of 0.5 mm in diameter×10 m in length. The column is first heated from 40° C. to 200° C. at a heating rate of 40° C./min, further heated to 350° C. at a heating rate of 15° C./min, and then heated to 450° C. at a heating rate of 7° C./min. He gas is injected as a carrier gas under pressure conditions of 50 kPa.

The compounds can be identified: by separately injecting a structurally known ester wax and comparing the retention time of the sample with that of this ester wax; or by introducing gasified components into a mass spectrometer and analyzing their spectra.

Also, the molecular weight of the ester wax can be determined from the structure determined by the approach mentioned above.

<Measurement of Glass Transition Temperature of Toner>

DSC measurement is performed according to JIS K 7121 (international standard: ASTM D3418-82). The DSC used in the present embodiment can be, for example, “Q1000” (manufactured by TA Instruments Japan Inc.). The temperature of a detection section in the apparatus was corrected using the melting points of indium and zinc. The heat quantity was corrected using the heat of fusion of indium.

For the measurement, first, approximately 10 mg of toner was precisely weighed into an aluminum pan. An empty aluminum pan was used as a reference. In the first heating process, the assay sample was assayed while the temperature was raised from 20° C. to 200° C. at a rate of 10° C./min. Then, the sample was assayed while the temperature was kept at 200° C. for 10 minutes, followed by a cooling process of lowering the temperature from 200° C. to 20° C. at a rate of 10° C./min.

The sample was further assayed while the temperature was kept at 20° C. for 10 minutes, followed by the second heating process of raising again the temperature from 20° C. to 200° C. at a rate of 10° C./min. Under these measurement conditions, a DSC curve was obtained to determine the glass transition temperature Tg1 in the first heating process and the glass transition temperature Tg2 in the second heating process.

<Method for Measuring Coverage Ratio X1>

The coverage ratio X1 of the surface of the toner particles with the silica fine particles is calculated as follows:

The elemental analysis of the surface of the toner particles is conducted using the following apparatus under the following conditions:

Measurement apparatus: Quantum 2000 (trade name; manufactured by Ulvac-Phi, Inc.)

X-ray source: monochrome Al Kα

X-ray setting: 100 μmφ (25 W (15 KV))

Photoelectron take-off angle: 45 degrees

Neutralization conditions: combined use of a neutralization gun and an ion gun

Analysis region: 300 μm×200 μm

Pass energy: 58.70 eV

Step size: 1.25 eV

Analysis software: PHI Multipak

In this context, the quantitative value of Si atoms was calculated using C 1c (B.E. 280 to 295 eV), O 1s (B.E. 525 to 540 eV) and Si 2p (B.E. 95 to 113 eV) peaks. The quantitative value of Si elements thus obtained is designated as Y1.

Subsequently, the elemental analysis of the silica fine particles alone is conducted in the same way as in the elemental analysis of the surface of the toner particles. The quantitative value of Si elements thus obtained is designated as Y2.

In the present invention, the coverage ratio X1 of the surface of the toner particles with the silica fine particles is defined according to the following expression using Y1 and Y2:

Coverage ratio X1(% by area)=(Y1/Y2)×100

In this context, Y1 and Y2 can be measured two or more times for improving the precision of the assay.

For the determination of the quantitative value Y2, the silica fine particles used in external addition may be used in the assay, if available.

In the case of using the silica fine particles separated from the surface of the toner particles as an assay sample, the separation of the silica fine particles from the toner particles is performed by procedures given below.

1) In the Case of Magnetic Toner

First, 6 mL of Contaminon N (aqueous solution containing 10% by mass of a neutral (pH 7) cleanser for cleaning of precision analyzers which is composed of a nonionic surfactant, an anionic surfactant and an organic builder; manufactured by Wako Pure Chemical Industries, Ltd.) is added to 100 mL of ion-exchanged water to prepare a dispersion medium. To this dispersion medium, 5 g of toner is added and dispersed for 5 minutes in an ultrasonic disperser. Then, the resultant dispersion is loaded in a “KM Shaker” (model: V. SX) manufactured by Iwaki Industry Co., Ltd., and reciprocally shaken for 20 minutes under conditions of 350 rpm. Thereafter, the toner particles are held back with a neodymium magnet, and the supernatant is collected. This supernatant is dried to thereby collect the silica fine particles. If a sufficient amount of silica fine particles cannot be collected, this operation is repeatedly performed.

In this method, external additives other than the silica fine particles, if added, can also be collected. In such a case, the silica fine particles used can be sorted out from the collected external additives by a centrifugation method or the like.

2) In the Case of Nonmagnetic Toner

160 g of sucrose (manufactured by Kishida Chemical Co., Ltd.) is added to 100 mL of ion-exchanged water and dissolved using a hot water bath to prepare a sucrose syrup. 31 g of the sucrose syrup and 6 mL of Contaminon N are added to a centrifuge tube to prepare a dispersion. To this dispersion, 1 g of toner is added, and clumps of the toner are broken up with a spatula or the like.

The centrifuge tube is reciprocally shaken for 20 minutes under conditions of 350 rpm on the shaker mentioned above. The solution thus shaken is transferred to a 50 mL glass tube for swing rotors and centrifuged under conditions of 3500 rpm for 30 minutes in a centrifuge. In the glass tube thus centrifuged, toner is present in the uppermost layer while silica fine particles are present on the aqueous solution side serving as the bottom layer. The aqueous solution serving as the bottom layer is collected and centrifuged to separate the silica fine particles from the sucrose and thereby collect the silica fine particles. If necessary, centrifugation is repeatedly performed for thorough separation, followed by drying of the dispersion and collection of the silica fine particles.

As with the magnetic toner, external additives other than the silica fine particles, if added, can also be collected. The silica fine particles are therefore sorted out from the collected external additives by a centrifugation method or the like.

<Method for Measuring Weight-Average Particle Size (D4) of Toner>

The weight-average particle size (D4) of the toner (particles) is calculated as described below. The measurement apparatus used is a precision particle size distribution measurement apparatus “Coulter Counter Multisizer 3(R)” (manufactured by Beckman Coulter, Inc.) which is based on the pore electrical resistance method and equipped with a 100 μm aperture tube. Dedicated software “Beckman Coulter Multisizer 3, Version 3.51” (manufactured by Beckman Coulter, Inc.) attached to the apparatus is used for setting the measurement conditions and analyzing the measurement data. The measurement is performed with 25,000 effective measurement channels.

The aqueous electrolyte solution used in the measurements is prepared by the dissolution of special-grade sodium chloride at a concentration of approximately 1% by mass in ion-exchanged water, and, for example, “ISOTON II” (manufactured by Beckman Coulter, Inc.) can be used.

The dedicated software is set as follows prior to measurement and analysis:

In the “Changing Standard Operating Mode (SOM)” screen of the dedicated software, the Total Count of the Control Mode is set to 50000 particles, and the Number of Runs and the Kd value are set to 1 and to the value obtained using “Standard particles 10.0 μm” (manufactured by Beckman Coulter), respectively. The “Threshold/Noise Level Measuring Button” is pressed to thereby automatically set the threshold and noise levels. Also, the Current is set to 1600 μA, the Gain is set to 2, and the Electrolyte Solution is set to ISOTON II. A check mark is placed in “Flush aperture tube following measurement.”

In the “Setting Conversion from Pulses to Particle Size” screen of the dedicated software, the Bin Interval is set to a logarithmic particle size, the Particle Size Bin is set to 256 particle size bins, and the Particle Size Range is set to from 2 μm to 60 μm.

Specific measurement methods are as described below.

(1) Approximately 200 mL of the aqueous electrolyte solution is placed in a 250 mL round-bottomed glass beaker dedicated to Multisizer 3. The beaker is loaded on a sample stand and stirred counterclockwise with a stirrer rod at a speed of 24 rotations per second. Then, debris and air bubbles are removed from the aperture tube by the “Aperture Flush” function of the dedicated software.

(2) Approximately 30 mL of the aqueous electrolyte solution is placed in a 100 mL flat-bottomed glass beaker. Approximately 0.3 mL of a dilution containing a dispersant “Contaminon N” (aqueous solution containing 10% by mass of a neutral (pH 7) cleanser for cleaning of precision analyzers which is composed of a nonionic surfactant, an anionic surfactant and an organic builder; manufactured by Wako Pure Chemical Industries, Ltd.) diluted approximately 3-fold by mass with ion-exchanged water is added into the beaker.

(3) “Ultrasonic Dispersion System Tetora 150” (manufactured by Nikkaki Bios Co., Ltd.) is prepared as an ultrasonic disperser having an electrical output of 120 W and internally equipped with two oscillators that oscillate at a frequency of 50 kHz and are disposed at a phase offset of 180 degrees. Approximately 3.3 l of ion-exchanged water is placed in the water tank of the ultrasonic disperser, and approximately 2 mL of Contaminon N is added to the water tank.

(4) The beaker prepared in (2) is loaded in a beaker-securing hole of the ultrasonic disperser, which is in turn operated. Then, the height position of the beaker is adjusted so as to maximize the resonance state of the liquid level of the aqueous electrolyte solution in the beaker.

(5) While the aqueous electrolyte solution in the beaker of (4) is ultrasonically irradiated, approximately 10 mg of toner is added in small portions to the aqueous electrolyte solution and dispersed therein. Then, the ultrasonic dispersion treatment is further continued for 60 seconds. For this ultrasonic dispersion, the temperature of water in the water tank is appropriately adjusted to 10° C. or higher and 40° C. or lower.

(6) The aqueous electrolyte solution of (5) containing the dispersed toner is added dropwise using a pipette to the round-bottomed beaker of (1) loaded in the sample stand to adjust the measurement concentration to approximately 5%. Then, the measurement is performed until the number of measured particles reaches 50000.

(7) The measurement data is analyzed using the dedicated software attached to the apparatus to calculate the weight-average particle size (D4). In this context, when Graph/% by Volume is selected in the dedicated software, the “Average Size” in the “Analysis/Volume Statistics (arithmetic average)” screen is the weight-average particle size (D4).

### EXAMPLES

Hereinafter, the present invention will be described more specifically with reference to Production Examples and Examples. However, the present invention is not intended to be limited by these examples by any means. In Examples given below, the unit “part” in each formulation represents part by mass.

<Production of Ester Wax 1>

Materials given below were added to a reaction apparatus equipped with a Dimroth condenser, a Dean-Stark water separator and a thermometer, and dissolved by sufficient stirring, followed by reflux for 6 hours. Then, the valve of the water separator was opened, and azeotropic distillation was performed.
Benzene 300 parts by mol
Docosanol (behenyl alcohol) 200 parts by mol
Sebacic acid 100 parts by mol
p-Toluenesulfonic acid 10 parts by mol

After the azeotropic distillation, the residue was thoroughly washed with sodium bicarbonate and then dried, and benzene was distilled off. The obtained product was recrystallized, then washed and purified to obtain an ester compound D-22.

Similarly, an ester compound D-20 was obtained using eicosanol instead of behenyl alcohol.

Further, an ester compound D-18 was obtained using octadecanol instead of behenyl alcohol.

These compounds D-18, D-20 and D-22 were melt-mixed at the ratio described in Table 1. The mixture was cooled and then cracked to obtain an ester wax 1. Table 1 also shows the composition ratio of the ester wax 1 measured by GC.

TABLE 1

| | | | The number of | | | |
|---|---|---|---|---|---|---|
| | | | carbon atoms | | | GC |
| | Structural | Index | in R1, R2 or | Molecular | Mixing | composition |
| | formula | of x | R3, R4 | weight | ratio | ratio |
| D-18 | Formula (2) | 8 | R3 = 18 | 707.2 | 5% | 5% |
| | | | R4 = 18 | | | |
| D-20 | Formula (2) | 8 | R3 = 20 | 763.3 | 31% | 31% |
| | | | R4 = 20 | | | |
| D-22 | Formula (2) | 8 | R3 = 22 | 819.4 | 64% | 64% |
| | | | R4 = 22 | | | |

<Production of Ester Waxes 2 to 14 and 17>

Ester waxes 2 to 14 and 17 were produced in the same way as in the production of the ester wax 1 except that docosanol and sebacic acid used in the production of the ester wax 1 were changed to the compounds shown in Table 2. The physical properties of each ester wax are shown in Table 2.

<Production of Ester Wax 15>

Materials given below were added to a reaction apparatus equipped with a Dimroth condenser, a Dean-Stark water separator and a thermometer, and dissolved by sufficient stirring, followed by reflux for 6 hours. Then, the valve of the water separator was opened, and azeotropic distillation was performed.

| | | |
|---|---|---|
| Benzene | 300 | parts by mol |
| Docosanol (behenyl alcohol) | 200 | parts by mol |
| Docosanoic acid (behenic acid) | 200 | parts by mol |
| p-Toluenesulfonic acid | 10 | parts by mol |

After the azeotropic distillation, the residue was thoroughly washed with sodium bicarbonate and then dried, and benzene was distilled off. The obtained product was recrystallized, then washed and purified to obtain an ester wax 15. The physical properties of the obtained ester wax 15 are shown in Table 2.

<Production of Ester Wax 16>

An ester wax 16 was produced in the same way as in the production of the ester wax 1 except that 200 parts by mol of docosanol and 100 parts by mol of sebacic acid used in the production of the ester wax 1 were changed to 100 parts by mol of glycerin and 300 parts by mol of docosanoic acid, respectively. The physical properties of the ester wax 16 are shown in Table 2.

TABLE 2

| | | | The number of | | | Content of |
|---|---|---|---|---|---|---|
| | | | carbon atoms | Content | | ester satisfying |
| Ester | Structural | Index | in R1, R2 or | of | Melting | 0.8 × M1 ≦ |
| wax | formula | of x | R3, R4 | ester A | point | M ≦ 1.2 × M1 |
| 1 | Formula (2) | 8 | R3 = 22 | 64% | 73.5° C. | 100% |
| | | | R4 = 22 | | | |
| 2 | Formula (2) | 10 | R3 = 22 | 64% | 78.5° C. | 100% |
| | | | R4 = 22 | | | |
| 3 | Formula (1) | 8 | R1 = 22 | 64% | 74.2° C. | 100% |
| | | | R2 = 22 | | | |
| 4 | Formula (1) | 9 | R1 = 22 | 64% | 75.0° C. | 100% |
| | | | R2 = 22 | | | |
| 5 | Formula (1) | 10 | R3 = 22 | 64% | 78.5° C. | 100% |
| | | | R4 = 22 | | | |
| 6 | Formula (2) | 8 | R3 = 22 | 40% | 71.5° C. | 90% |
| | | | R4 = 22 | | | |
| 7 | Formula (2) | 8 | R3 = 16 | 80% | 65.0° C. | 100% |
| | | | R4 = 16 | | | |
| 8 | Formula (1) | 9 | R1 = 26 | 40% | 80.0° C. | 90% |
| | | | R2 = 26 | | | |
| 9 | Formula (2) | 8 | R3 = 14 | 80% | 61.4° C. | 100% |
| | | | R4 = 14 | | | |
| 10 | Formula (1) | 9 | R1 = 28 | 40% | 83.4° C. | 90% |
| | | | R2 = 28 | | | |
| 11 | Formula (2) | 8 | R3 = 24 | 35% | 70.2° C. | 90% |
| | | | R4 = 24 | | | |
| 12 | Formula (2) | 8 | R3 = 16 | 90% | 67.2° C. | 100% |
| | | | R4 = 16 | | | |
| 13 | Formula (1) | 9 | R1 = 26 | 35% | 76.6° C. | 90% |
| | | | R2 = 26 | | | |
| 14 | Formula (1) | 9 | R1 = 20 | 90% | 72.7° C. | 100% |
| | | | R2 = 20 | | | |
| 15 | Behenyl behenate | | | 100% | 73.8° C. | 100% |
| 16 | Glycerin | | R1 = 22 | 64% | 80.0° C. | 100% |
| | | | R2 = 22 | | | |
| 17 | Formula (2) | 8 | R3 = 22 | 62% | 72.4° C. | 85% |
| | | | R4 = 22 | | | |

<Production of Magnetic Powder>

1.1 equivalents of a caustic soda solution with respect to iron elements, 0.12% by mass of P₂O₅ based on phosphorus elements with respect to iron elements and 0.55% by mass of SiO₂ based on silicon elements with respect to iron elements were mixed into an aqueous ferrous sulfate solution to prepare an aqueous solution containing ferrous hydroxide. While air was blown into the aqueous solution with its pH kept at 7.5, oxidation reaction was performed at a temperature of 85° C. to prepare a slurry solution having seed crystals.

Subsequently, an aqueous ferrous sulfate solution was added at 1.1 equivalents with respect to the initial amount of the alkali (sodium component in the caustic soda) to this slurry solution. While air was blown into the slurry solution with its pH kept at 7.6, oxidation reaction was allowed to proceed to obtain a slurry solution containing magnetic iron oxide. After filtration and washing, this water-containing slurry solution was temporarily isolated. A small amount of a water-containing sample is collected from this slurry solution, and its water content was measured.

Next, this water-containing sample was added without drying into a fresh aqueous medium and redispersed using a pin mill while the slurry was allowed to circulate with stirring. The pH of the redispersion was adjusted to approximately 4.8. Then, 1.5 parts by mass of n-hexyltrimethoxysilane with respect to 100 parts by mass of the magnetic iron oxide (the amount of the magnetic iron oxide was calculated as a value determined by subtracting the water content from the amount of the water-containing sample) were added thereto for hydrolysis.

Thereafter, the sample was dispersed using a pin mill while the slurry was allowed to circulate with sufficient stirring. The pH of the dispersion was adjusted to 8.6, followed by hydrophobization treatment. The obtained hydrophobic magnetic powder was filtered by filter press, washed with a large amount of water and then dried at a temperature of 100° C. for 15 minutes and at 90° C. for 30 minutes. The obtained particles were cracked to obtain a magnetic powder 1 having a volume-average particle size (D3) of 0.21 μm.

<Production of Toner Particles 1>

450 parts by mass of a 0.1 mol/L aqueous Na₃PO₄ solution were added to 720 parts by mass of ion-exchanged water, and the mixture was heated to a temperature of 60° C. Then, 67.7 parts by mass of a 1.0 mol/L aqueous CaCl₂ solution were added thereto to obtain an aqueous medium containing the dispersant.

| | | |
|---|---|---|
| Styrene | 76.0 | parts by mass |
| n-Butyl acrylate | 24.0 | parts by mass |
| Divinylbenzene | 0.48 | parts by mass |
| Iron complex of monoazo dye (T-77, manu- | 1.5 | parts by mass |
| factured by Hodogaya Chemical Co., Ltd.) | | |
| Magnetic powder 1 | 90.0 | parts by mass |
| Polyester resin (polycondensate of propylene | 5.0 | parts by mass |
| oxide-modified bisphenol A (2 mol adduct) and | | |
| terephthalic acid (polymerization ratio by | | |
| mol = 10:12), Tg = 68° C., Mw = | | |
| 10000, Mw/Mn = 5.12) | | |

The formulation mentioned above was uniformly dispersed and mixed using an attritor (Nippon Coke & Engineering. Co., Ltd. (former Mitsui Miike Machinery Co., Ltd.)) to obtain a monomer composition. This monomer composition was heated to 60° C. 10 parts by mass of the ester wax 1 were added and mixed thereto. After dissolution, 4.5 parts by mass of a polymerization initiator 2,2′-azobis(2,4-dimethylvaleronitrile) were dissolved in the solution.

The monomer composition was added into the aqueous medium and stirred using a TK homomixer (PRIMIX Corporation (former Tokushu Kika Kogyo Co., Ltd.)) at 12000 rpm at 60° C. for 10 minutes in a N₂ atmosphere for granulation. Then, reaction was performed at a temperature of 70° C. for 5 hours with stirring using Fullzone stirring blade.

(Step a)

After the completion of the polymerization reaction, saturated water vapor (pure steam/steam pressure: 205 kPa, temperature: 120° C.) was introduced into the reaction product while the stirring was continued using Fullzone stirring blade. After the temperature of the contents in the container reached 100° C., heat treatment was performed for 180 minutes with residual monomers distilled off.

(Step b)

After the completion of Step a, cooling was performed from the temperature of 100° C. at a rate of 0.5° C./min. When the temperature reached 55.0° C., heat treatment was performed for 180 minutes with the temperature controlled such that the range of temperature fluctuations centered on 55.0° C. was 2.0° C. Then, cooling was performed to a temperature of 30° C. at a rate of 0.25° C./min.

After the cooling, hydrochloric acid was added to the product, which was in turn washed, then filtered and dried to obtain toner particles 1.

<Production of Toner Particles 2 to 23>

Toner particles 2 to 23 were produced in the same way as in the Production Example of the toner particles 1 except that the type and the number of parts of the wax were changed to those shown in Table 3 and the conditions of (Step a) and (Step b) were changed as shown in Table 3. The weight-average particles sizes (D4) of the toner particles 1 to 23 are shown in Table 3.

TABLE 3

| | Ester wax | | | | | | |
|---|---|---|---|---|---|---|---|
| | | Amount added | | | Weight-average | | |
| Toner | | (parts | Production | Production | particle size | | Tg2 − |
| particles | Type | by mass) | step (a) | step (b) | (D4) | Tg1 | Tg1 |
| 1 | 1 | 10 | 100° C./180 min | 55° C./180 min | 7.8 μm | 55° C. | 12° C. |
| 2 | 2 | 10 | 100° C./180 min | 58° C./180 min | 8.0 μm | 56° C. | 12° C. |
| 3 | 3 | 10 | 100° C./180 min | 55° C./180 min | 7.6 μm | 54° C. | 12° C. |
| 4 | 4 | 10 | 100° C./180 min | 55° C./180 min | 7.4 μm | 55° C. | 11° C. |
| 5 | 5 | 10 | 100° C./180 min | 58° C./180 min | 7.9 μm | 53° C. | 10° C. |
| 6 | 1 | 10 | 100° C./180 min | 55° C./30 min | 8.0 μm | 52° C. | 10° C. |
| 7 | 1 | 10 | 100° C./180 min | Not performed | 7.8 μm | 49° C. | 8° C. |
| 8 | 1 | 5 | 100° C./180 min | Not performed | 7.9 μm | 52° C. | 6° C. |
| 9 | 1 | 20 | 100° C./180 min | Not performed | 7.9 μm | 46° C. | 8° C. |
| 10 | 1 | 22 | 100° C./180 min | Not performed | 7.5 μm | 45° C. | 9° C. |
| 11 | 1 | 4 | 100° C./180 min | Not performed | 8.1 μm | 52° C. | 5° C. |
| 12 | 6 | 4 | 100° C./180 min | Not performed | 7.8 μm | 52° C. | 5° C. |
| 13 | 7 | 4 | 100° C./180 min | Not performed | 7.4 μm | 52° C. | 5° C. |
| 14 | 8 | 4 | 100° C./180 min | Not performed | 7.6 μm | 52° C. | 5° C. |
| 15 | 9 | 10 | 100° C./180 min | 50° C./180 min | 7.8 μm | 45° C. | 3° C. |
| 16 | 10 | 10 | 100° C./180 min | 70° C./180 min | 7.9 μm | 47° C. | 7° C. |
| 17 | 11 | 10 | 100° C./180 min | 53° C./180 min | 7.5 μm | 48° C. | 2° C. |
| 18 | 12 | 10 | 100° C./180 min | 53° C./180 min | 7.4 μm | 50° C. | 12° C. |
| 19 | 13 | 10 | 100° C./180 min | 58° C./180 min | 7.8 μm | 53° C. | 11° C. |
| 20 | 14 | 10 | 100° C./180 min | 55° C./180 min | 7.7 μm | 58° C. | 12° C. |
| 21 | 15 | 10 | 100° C./180 min | 55° C./180 min | 8.0 μm | 55° C. | 5° C. |
| 22 | 16 | 10 | 100° C./180 min | 70° C./180 min | 7.3 μm | 46° C. | 3° C. |
| 23 | 17 | 10 | 100° C./180 min | 55° C./30 min | 7.7 μm | 51° C. | 5° C. |

<Production of Toner 1>

The toner particles 1 were subjected to external addition and mixing treatment using the apparatus illustrated in FIG. 2.

In the present Example, the apparatus illustrated in FIG. 2 was configured such that: the diameter of the inner periphery of the main casing 1 was 130 mm; and the volume of the treatment space 9 was 2.0×10⁻³ m³. In the apparatus used, the rated power of the driving member 8 was 5.5 kW, and the stirring members 3 were shaped as illustrated in FIG. 3. In addition, the width d of the overlap between the stirring members 3a and the stirring members 3b in FIG. 3 was set to 0.25D with respect to the maximum width D of the stirring members 3, and the clearance between the stirring members 3 and the inner periphery of the main casing 1 was set to 3.0 mm.

Materials given below were introduced into the apparatus of FIG. 2 configured as described above.

| | | |
|---|---|---|
| Toner particles 1 | 100 | parts by mass |
| Silica fine particles (number-average particle size | 0.50 | parts by mass |
| of silica bulk as primary particles: 7 nm, BET | | |
| specific surface area: 300 m²/g, rate of fixation | | |
| based on the amount of carbon atoms of silicone | | |
| oil: 98%, apparent density: 25 g/L, number- | | |
| average particle size of treated silica fine | | |
| particles as primary particles: 8 nm) | | |

After the introduction of the toner particles and the silica fine particles, premixing was carried out in order to uniformly mix the toner particles and the silica fine particles. Conditions for this premixing involved a power of the driving member 8 set to 0.10 W/g (rotational speed of the driving member 8: 150 rpm) and a treatment time set to 1 minute.

After the completion of the premixing, the external addition and mixing treatment was performed. Conditions for the external addition and mixing treatment involved: adjusting the peripheral speed of the stirring members 3 at the outermost end portions thereof so as to set the power of the driving member 8 to the constant value of 0.60 W/g (rotational speed of the driving member 8: 1400 rpm); and a treatment time set to 5 minutes. The conditions for the external addition and mixing treatment are shown in Table 3.

After the external addition and mixing treatment, coarse particles, etc. were removed using a circular vibrating screen equipped with a screen having a diameter of 500 mm and an aperture of 75 μm to obtain toner 1. The external addition conditions and physical properties of the toner 1 are shown in Table 4.

<Production of Toners 2 to 34>

Toners 2 to 34 were produced in the same way as in the Production Example of the toner 1 except that the toner particles and the external addition conditions were changed to those shown in Table 4. The physical properties of the toners 2 to 34 are shown in Table 4.

TABLE 4

| | | The | | | | External | | | | |
|---|---|---|---|---|---|---|---|---|---|---|
| | | number of | | Premixing step | | addition step | | Coverage | | Lower |
| | | parts by | External | | Rotational | | Rotational | ratio | | limit of |
| | Toner | mass of | addition | Power | speed | Power | speed | X1 (% | Diffusion | diffusion |
| Toner | particles | silica | apparatus | (W/g) | (rpm) | (W/g) | (rpm) | by area) | index | index |
| 1 | 1 | 0.50 | FIG. 2 | 0.10 | 150 | 0.60 | 1400 | 50 | 0.50 | 0.41 |
| 2 | 2 | 0.50 | FIG. 2 | 0.10 | 150 | 0.60 | 1400 | 50 | 0.50 | 0.41 |
| 3 | 3 | 0.50 | FIG. 2 | 0.10 | 150 | 0.60 | 1400 | 50 | 0.50 | 0.41 |
| 4 | 4 | 0.50 | FIG. 2 | 0.10 | 150 | 0.60 | 1400 | 50 | 0.50 | 0.41 |
| 5 | 5 | 0.50 | FIG. 2 | 0.10 | 150 | 0.60 | 1400 | 50 | 0.50 | 0.41 |
| 6 | 6 | 0.50 | FIG. 2 | 0.10 | 150 | 0.60 | 1400 | 50 | 0.50 | 0.41 |
| 7 | 7 | 0.50 | FIG. 2 | 0.10 | 150 | 0.60 | 1400 | 50 | 0.50 | 0.41 |
| 8 | 8 | 0.50 | FIG. 2 | 0.10 | 150 | 0.60 | 1400 | 50 | 0.50 | 0.41 |
| 9 | 9 | 0.50 | FIG. 2 | 0.10 | 150 | 0.60 | 1400 | 50 | 0.50 | 0.41 |
| 10 | 10 | 0.50 | FIG. 2 | 0.10 | 150 | 0.60 | 1400 | 50 | 0.50 | 0.41 |
| 11 | 11 | 0.50 | FIG. 2 | 0.10 | 150 | 0.60 | 1400 | 50 | 0.50 | 0.41 |
| 12 | 11 | 0.70 | FIG. 2 | 0.10 | 150 | 0.60 | 1400 | 63 | 0.47 | 0.36 |
| 13 | 11 | 0.42 | FIG. 2 | 0.10 | 150 | 0.60 | 1400 | 45 | 0.53 | 0.43 |
| 14 | 11 | 0.90 | FIG. 2 | 0.10 | 150 | 0.60 | 1400 | 75 | 0.42 | 0.31 |
| 15 | 11 | 0.40 | FIG. 2 | 0.10 | 150 | 0.60 | 1400 | 40 | 0.58 | 0.45 |
| 16 | 11 | 0.60 | FIG. 2 | 0.06 | 50 | 0.60 | 1400 | 50 | 0.41 | 0.41 |
| 17 | 11 | 0.90 | FIG. 2 | 0.06 | 50 | 0.60 | 1400 | 62 | 0.36 | 0.36 |
| 18 | 11 | 1.20 | FIG. 2 | 0.06 | 50 | 0.60 | 1400 | 75 | 0.31 | 0.31 |
| 19 | 12 | 0.50 | FIG. 2 | 0.10 | 150 | 0.60 | 1400 | 50 | 0.50 | 0.41 |
| 20 | 13 | 0.50 | FIG. 2 | 0.10 | 150 | 0.60 | 1400 | 50 | 0.50 | 0.41 |
| 21 | 14 | 0.50 | FIG. 2 | 0.10 | 150 | 0.60 | 1400 | 50 | 0.50 | 0.41 |
| 22 | 15 | 0.50 | FIG. 2 | 0.10 | 150 | 0.60 | 1400 | 50 | 0.50 | 0.41 |
| 23 | 16 | 0.50 | FIG. 2 | 0.10 | 150 | 0.60 | 1400 | 50 | 0.50 | 0.41 |
| 24 | 17 | 0.50 | FIG. 2 | 0.10 | 150 | 0.60 | 1400 | 50 | 0.50 | 0.41 |
| 25 | 18 | 0.50 | FIG. 2 | 0.10 | 150 | 0.60 | 1400 | 50 | 0.50 | 0.41 |
| 26 | 19 | 0.50 | FIG. 2 | 0.10 | 150 | 0.60 | 1400 | 50 | 0.50 | 0.41 |
| 27 | 20 | 0.50 | FIG. 2 | 0.10 | 150 | 0.60 | 1400 | 50 | 0.50 | 0.41 |
| 28 | 21 | 0.50 | FIG. 2 | 0.10 | 150 | 0.60 | 1400 | 50 | 0.50 | 0.41 |
| 29 | 22 | 0.50 | FIG. 2 | 0.10 | 150 | 0.60 | 1400 | 50 | 0.50 | 0.41 |
| 30 | 23 | 0.50 | FIG. 2 | 0.10 | 150 | 0.60 | 1400 | 50 | 0.50 | 0.41 |
| 31 | 1 | 0.30 | FIG. 2 | 0.06 | 50 | 0.60 | 1400 | 36 | 0.53 | 0.47 |

| | | | | | | | | | |
|---|---|---|---|---|---|---|---|---|---|
| 32 | 1 | 0.70 | HM | None | — | 4000 | 50 | 0.38 | 0.41 |
| 33 | 1 | 1.10 | HM | None | — | 4000 | 62 | 0.35 | 0.36 |
| 34 | 1 | 1.50 | HM | None | — | 4000 | 75 | 0.30 | 0.31 |

External addition apparatus: “FIG. 2” means the “apparatus illustrated in FIG. 2”, and “HM” represents a “Henschel mixer”.
“Lower limit of diffusion index” refers to the value of (−0.0042×X1+0.62) in the expression (4).

### Example 1

The image forming apparatus used was LBP-3100 (manufactured by Canon Inc.) adapted such that a film-fixing member had variable temperatures and a printing speed was changed from 16 sheets/min to 24 sheets/min.

For the tests of low-temperature fixability and low-temperature offset, evaluation was conducted in an environment of low temperature and low humidity (temperature: 7.5° C., relative humidity: 10% RH). The fixation medium used was FOX RIVER BOND paper (75 g/m²).

The low temperature of the surrounding environment during fixation and the low temperature of the paper serving as a medium as mentioned above create conditions disadvantageous for heat transfer during fixation, while the medium having relatively large surface asperities is used as the medium itself. In this way, the fixability can be strictly evaluated.

<Low-Temperature Fixability>

As for the low-temperature fixability, a halftone image was output onto FOX RIVER BOND paper at a temperature set to 200° C. with its density adjusted such that the image density measured using a Macbeth reflection densitometer (manufactured by Macbeth Corporation) was 0.75 or higher and 0.80 or lower.

Thereafter, images were further output while the set temperature of the fixing member was decreased from 210° C. by 5° C. for each run. Then, the fixed images were rubbed 10 times using lens-cleaning paper under a load of 55 g/cm² to confirm the strength of the fixation. The temperature that resulted in more than 10% rate of reduction in the densities of the fixed images thus rubbed was defined as the lower limit of the fixation temperature. Toner having a lower value of this temperature has higher low-temperature fixability.

<Low-Temperature Offset>

For the evaluation of the low-temperature offset, a solid image of 2.0 cm long and 15.0 cm wide was formed in a portion 2.0 cm from the upper end and in a portion 2.0 cm from the lower end in the paper feed direction on FOX RIVER BOND paper. The image was output with its density adjusted such that the image density measured using a Macbeth reflection densitometer (manufactured by Macbeth Corporation) was 1.40 or higher and 1.50 or lower. Images were further output while the set temperature of the fixing member was decreased from 210° C. by 5° C. for each run. The temperature that caused offset was visually determined for the evaluation.

<Fog>

A white image was output onto A4-size 80 g/m² paper in an environment of low temperature and low humidity (temperature: 7.5° C., relative humidity: 10% RH). Its reflectivity was measured using REFLECTMETER MODEL TC-6DS manufactured by Tokyo Denshoku Co., Ltd. On the other hand, the reflectivity of transfer paper (normal paper) before white image formation was measured in the same way as above. The filter used was a green filter. The fogs were calculated from the reflectivities before and after the white image output according to the following expression:

Fog(%)=Reflectivity(%) on normal paper−Reflectivity(%) of the white image sample

### Examples 2 to 21

Evaluation was conducted in the same way as in Example 1 using the toners 2 to 21.

As a result, the toners successfully produced images having no practical problems in all of the evaluated items. The evaluation results are shown in Table 5.

### Comparative Examples 1 to 13

Images were output and tested in the same way as in Example 1 except that the toners 22 to 34 were used. As a result, all of the toners were impractical in terms of all or any of the low-temperature fixability, the low-temperature offset and the fogs. The evaluation results are shown in Table 5.

TABLE 5

| | | | Temperature | |
|---|---|---|---|---|
| | | Lower limit | causing low- | |
| | | of fixation | temperature | |
| | Toner | temperature | offset | Fog |
| Example 1 | Toner 1 | 150° C. | 145° C. | 1.0% |
| Example 2 | Toner 2 | 155° C. | 145° C. | 1.2% |
| Example 3 | Toner 3 | 150° C. | 150° C. | 1.1% |
| Example 4 | Toner 4 | 150° C. | 150° C. | 1.0% |
| Example 5 | Toner 5 | 150° C. | 150° C. | 1.1% |
| Example 6 | Toner 6 | 150° C. | 150° C. | 1.0% |
| Example 7 | Toner 7 | 155° C. | 150° C. | 2.1% |
| Example 8 | Toner 8 | 160° C. | 160° C. | 1.7% |
| Example 9 | Toner 9 | 150° C. | 145° C. | 2.5% |
| Example 10 | Toner 10 | 150° C. | 145° C. | 3.3% |
| Example 11 | Toner 11 | 175° C. | 175° C. | 2.6% |
| Example 12 | Toner 12 | 180° C. | 175° C. | 2.6% |
| Example 13 | Toner 13 | 175° C. | 170° C. | 2.7% |
| Example 14 | Toner 14 | 180° C. | 180° C. | 1.8% |
| Example 15 | Toner 15 | 170° C. | 170° C. | 3.5% |
| Example 16 | Toner 16 | 175° C. | 180° C. | 2.9% |
| Example 17 | Toner 17 | 180° C. | 195° C. | 2.9% |
| Example 18 | Toner 18 | 190° C. | 195° C. | 2.5% |
| Example 19 | Toner 19 | 165° C. | 160° C. | 3.8% |
| Example 20 | Toner 20 | 190° C. | 185° C. | 2.0% |
| Example 21 | Toner 21 | 170° C. | 185° C. | 3.5% |
| Comparative Example 1 | Toner 22 | 150° C. | 170° C. | 4.1% |
| Comparative Example 2 | Toner 23 | 175° C. | 200° C. | 2.7% |
| Comparative Example 3 | Toner 24 | 160° C. | 170° C. | 4.5% |
| Comparative Example 4 | Toner 25 | 175° C. | 180° C. | 4.2% |
| Comparative Example 5 | Toner 26 | 170° C. | 200° C. | 4.8% |
| Comparative Example 6 | Toner 27 | 190° C. | 195° C. | 2.5% |
| Comparative Example 7 | Toner 28 | 190° C. | 190° C. | 3.0% |
| Comparative Example 8 | Toner 29 | 205° C. | 210° C. | 3.3% |
| Comparative Example 9 | Toner 30 | 180° C. | 190° C. | 4.5% |
| Comparative Example 10 | Toner 31 | 155° C. | 185° C. | 3.1% |
| Comparative Example 11 | Toner 32 | 160° C. | 190° C. | 5.1% |
| Comparative Example 12 | Toner 33 | 165° C. | 190° C. | 5.0% |
| Comparative Example 13 | Toner 34 | 180° C. | 205° C. | 4.6% |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-270110, filed Dec. 26, 2013, which is hereby incorporated by reference herein in its entirety.

What is claimed is:

1. Toner comprising
toner particles each containing a binder resin, a colorant and an ester wax, and
silica fine particles present on the surfaces of the toner particles, wherein:
the ester wax contains a plurality of esters represented by the following general formula (1) or (2):
R1-COO—(CH₂)ₓ₁—OOC—R2 General formula(1)
R3-OOC—(CH₂)ₓ₂—COO—R4 General formula(2)
wherein R1 to R4 each independently represent an alkyl group having 15 to 26 carbon atoms, and x1 and x2 each independently represent an integer of 8 to 10;
in the composition distribution of the ester wax measured by GC-MASS,
(i) when an ester whose content is maximum among the plurality of esters, is designated as “ester A”, a content of the ester A in the ester wax is 40% by mass or larger and 80% by mass or smaller based on the ester wax, and
(ii) when a molecular weight of the ester A is represented by M1, a content of an ester having a molecular weight of M1×0.8 or higher and M1×1.2 or lower among the esters contained in the ester wax is 90% by mass or larger based on the ester wax;
a coverage ratio X1 of the surface of the toner particles with the silica fine particles determined by electron spectroscopy for chemical analysis (ESCA) is 40.0% by area or more and 75.0% by area or less; and
when a theoretical coverage ratio of the surface of the toner particles with the silica fine particles is defined as X2, a diffusion index represented by the following expression (3) satisfies the following expression (4):
Diffusion index=X1/X2 Expression (3)
Diffusion index≧−0.0042×X1+0.62 Expression (4).

2. The toner according to claim 1, wherein a content of the ester wax is 5 parts by mass or larger and 20 parts by mass or smaller with respect to 100 parts by mass of the binder resin.

3. The toner according to claim 1, wherein the toner has a glass transition temperature Tg1 of 46° C. or higher and 60° C. or lower in a first heating process when measured using a differential scanning calorimeter, and has a 10° C. or more difference (Tg2−Tg1) of a glass transition temperature Tg2 in a second heating process from the glass transition temperature Tg1 in the first heating process when measured after cooling followed by reheating.

4. The toner according to claim 1, wherein the toner particles are toner particles produced in an aqueous medium.
